(19) United States
(12) Patent Application Publication
(10) Pub. No.: US 2002/0091515 A1
(43) Pub. Date: Jul. 11, 2002

(54) System and method for voice recognition in a distributed voice recognition system

(76) Inventor: Harinath Garudadri, San Diego, CA (US)

Correspondence Address: Qualcomm Incorporated, Patents Department, 5775 Morehouse Drive, San Diego, CA, 92121-1714, US

(21) Appl. No.: 09/755,651

(22) Filed: Jan. 5, 2001

(51) Int. Cl. G10L 15/00

(52) U.S. Cl. 704/231

(57) ABSTRACT

A method and system that improves voice recognition in a distributed voice recognition system. A distributed voice recognition system includes a local VR engine in a subscriber unit and a server VR engine on a server. When the local VR engine does not recognize a speech segment, the local VR engine sends information of the speech segment to the server VR engine If the speech segment is recognized by the server VR engine, then the server VR engine downloads information corresponding the speech segment to the local VR engine. The local VR engine may combine its speech segement information with downloaded information to create resultant information for a speech segment. The local VR engine may also apply a function to downloaded information to create resultant information. Resultant information then may be uploaded from the local VR engine to the server VR engine.

### BACKGROUND

I. Field

The present invention pertains generally to the field of communications and more specifically to a system and method for improving local voice recognition in a distributed voice recognition system.

II. Background

Voice recognition (VR) represents one of the most important techniques to endow a machine with simulated intelligence to recognize user or user-voiced commands and to facilitate human interface with the machine. VR also represents a key technique for human speech understanding. Systems that employ techniques to recover a linguistic message from an acoustic speech signal are called voice recognizers.

The use of VR (also commonly referred to as speech recognition) is becoming increasingly important for safety reasons. For example, VR may be used to replace the manual task of pushing buttons on a wireless telephone keypad. This is especially important when a user is initiating a telephone call while driving a car. When using a car telephone without VR, the driver must remove one hand from the steering wheel and look at the phone keypad while pushing the buttons to dial the call. These acts increase the likelihood of a car accident. A speech-enabled car telephone (i.e., a telephone designed for speech recognition) allows the driver to place telephone calls while continuously watching the road. In addition, a hands-free car-kit system would permits the driver to maintain both hands on the steering wheel during initiation of a telephone call.

Speech recognition devices are classified as either speaker-dependent (SD) or speaker-independent (SI) devices. Speaker-dependent devices, which are more common, are trained to recognize commands from particular users. In contrast, speaker-independent devices are capable of accepting voice commands from any user. To increase the performance of a given VR system, whether speaker-dependent or speaker-independent, a procedure called training is required to equip the system with valid parameters. In other words, the system needs to learn before it can function optimally.

A speaker-dependent VR system prompts the user to speak each of the words in the system's vocabulary once or a few times (typically twice) so the system can learn the characteristics of the user's speech for these particular words or phrases. An exemplary vocabulary for a hands-free car kit might include the ten digits; the keywords “call,” “send,” “dial,” “cancel,” “clear,” “add,” “delete,” “history,” “program,” “yes,” and “no”; and the names of a predefined number of commonly called coworkers, friends, or family members. Once training is complete, the user can initiate calls in the recognition phase by speaking the trained keywords, which the VR device recognizes by comparing the spoken utterances with the previously trained utterances (stored as templates) and taking the best match. For example, if the name “John” were one of the trained names, the user could initiate a call to John by saying the phrase “Call John.” The VR system would recognize the words “Call” and “John,” and would dial the number that the user had previously entered as John's telephone number. Systems and methods for training A speaker-independent VR device also uses a set of trained templates that allow a predefined vocabulary (e.g., certain control words, the numbers zero through nine, and yes and no). A large number of speakers (e.g., 100) must be recorded saying each word in the vocabulary.

A voice recognizer, i.e. a VR system, comprises an acoustic processor and a word decoder. The acoustic processor performs feature extraction. The acoustic processor extracts a sequence of information-bearing features (vectors) necessary for VR from the incoming raw speech. The word decoder decodes this sequence of features (vectors) to yield the meaningful and desired format of output, such as a sequence of linguistic words corresponding to the input utterance.

In a typical voice recognizer, the word decoder has greater computational and memory requirements than to the frontend of the voice recognizer. In an implementation of voice recognizers implemented using a distributed system architecture, it is often desirable to place the word-decoding task at the subsystem that can absorb the computational and memory load appropriately. The acoustic processor should reside as close to the speech source as possible to reduce the effects of quantization errors introduced by signal processing and/or channel induced errors. Thus, in a Distributed Voice Recognition (DVR) system, the acoustic processor resides within a user device and the word decoder resides on a network.

In a Distributed Voice Recognition system, frontend features are extracted in a device, such as a subscriber unit (also called mobile station, mobile, remote station, user device, or user equipment), and sent to a network. A server-based VR system within the network serves as the backend of the voice recognition system and performs word decoding. This has the benefit of performing complex VR tasks using the resources on the network. Examples of distributed VR systems are described in U.S. Pat. No. 5,956,683, assigned to the assignee of the present invention and incorporated by reference herein.

In addition to feature extraction being performed on the subscriber unit, simple VR tasks can be performed on the subscriber unit, in which case the VR system on the network is not used for simple VR tasks. Consequently, network traffic is reduced with the result that the cost of providing speech-enabled services is reduced.

Notwithstanding the subcriber unit performing simple VR tasks, traffic congestion on the network can result in subscriber units obtaining poor service from the server-based VR system. A distributed VR system enables rich user interface features using complex VR tasks, but at the price of increasing network traffic and sometimes delay. If a local VR engine does not recognize a user's spoken commands, then the user's spoken commands have to be transmitted to the server-based VR engine after frontend processing, thereby increasing network traffic. After the spoken commands are interpreted by the network-based VR engine, the results have to be transmitted back to the subcriber unit, which can introduce a significant delay if there is network congestion.

Thus, there is a need for a system and method to further improve local VR performance in the subsriber unit so that dependence on the server-based VR system is decreased. A system and method to improve local VR performance would have the benefit of improved accuracy for the local VR engine and ability to handle more VR tasks on the subcriber unit, further reducing the network traffic and eliminating delay.

### SUMMARY

The described embodiments are directed to a system and method for improving voice recognition in a distributed voice recognition system. In one aspect, a system and method for voice recognition includes a server VR engine on a server in a network recognizing a speech segment that a local VR engine on a subcriber unit does not recognize. In another aspect, a system and method for voice recognition includes a server VR engine downloading information of a speech segment to a local VR engine. In another aspect, the downloaded information is mixtures comprising mean and variance vectors of a speech segment. In another aspect, a system and method for voice recognition includes a local VR engine that combines downloaded mixtues with the local VR engine's mixtures to create resultant mixtures used by the local VR engine to recognize a speech segment. In another aspect, a system and method for voice recognition includes a local VR engine that applies a function to mixtures downloaded by a server VR engine to generate resultant mixtures used to recognize speech segments. In another aspect, a system and method for voice recognition includes a local VR engine for uploading resultant mixtures to a server VR engine.

### BRIEF DESCRIPTION OF THE DRAWINGS

FIG. 1 shows a voice recognition system;

FIG. 2 shows a VR frontend in a VR system;

FIG. 3 shows an example HMM model for a triphone;

FIG. 4 shows a DVR system with a local VR engine in a subscriber unit and a server VR engine on a server in accordance with one embodiment; and

FIG. 5 shows a flowchart of a VR recognition process in accordance with one embodiment.

### DETAILED DESCRIPTION OF PREFERRED EMBODIMENTS

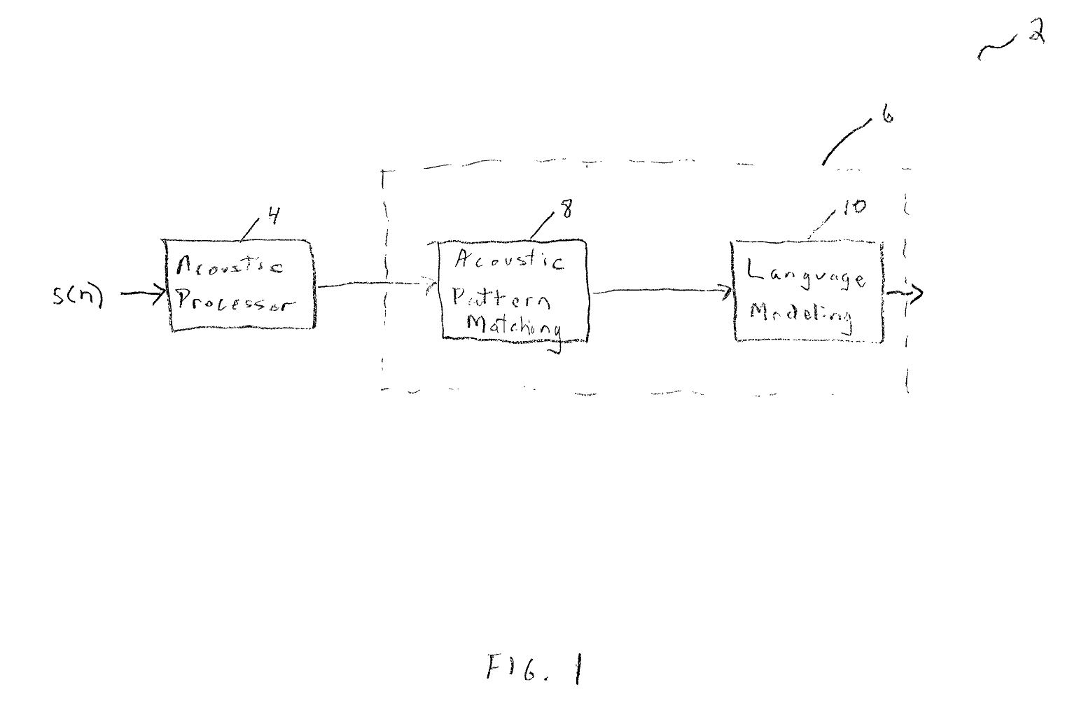

FIG. 1 shows a voice recognition system 2 including an Acoustic Processor 4 and a Word Decoder 6 in accordance with one embodiment. The Word Decoder 6 comprises an Acoustic Pattern Matching element 8 and a Language Modeling element 10. The Language Modeling element 10 is also called a grammar specification element. The Acoustic Processor 4 is coupled to the Acoustic Matching element 8 of the Word Decoder 6. The Acoustic Pattern Matching element 8 is coupled to a Language Modeling element 10.

The Acoustic Processor 4 extracts features from an input speech signal and provides those feature to the Word Decoder 6. Generally speaking, the Word Decoder 6 translates the acoustic features from the Acoustic Processor 4 into an estimate of the speaker's original word string. This is accomplished in two steps: acoustic pattern matching and language modeling. Language modeling can be avoided in applications of isolated word recognition. The Acoustic Pattern Matching element 8 detects and classifies possible acoustic patterns, such as phonemes, syllables, words, etc. The candidate patterns are provided to Language Modeling element 10, which models the rules of syntactic constraints that determine what sequences of words are grammatically well formed and meaningful. Syntactic information can be a valuable guide to voice recognition when acoustic information alone is ambiguous. Based on language modeling, the VR sequentially interprets the acoustic feature matching results and provides the estimated word string.

Both the acoustic pattern matching and language modeling in the Word Decoder 6 require a mathematical model, either deterministic or stochastic, to describe the speaker's phonological and acoustic-phonetic variations. The performance of a speech recognition system is directly related to the quality of these two models. Among the various classes of models for acoustic pattern matching, template-based dynamic time warping (DTW) and stochastic hidden Markov modeling (HMM) are the two most commonly used models. Those of skill in the art understand DTW and HMM.

HMM systems are currently the most successful speech recognition algorithms. The doubly stochastic property in HMM provides better flexibility in absorbing acoustic as well as temporal variations associated with speech signals. This usually results in improved recognition accuracy. Concerning the language model, a stochastic model called k-gram language model which is detailed in F. Jelink, “The Development of an Experimental Discrete Dictation Recognizer”, Proc. IEEE, vol. 73, pp. 1616-1624, 1985, has been successfully applied in practical large vocabulary voice recognition systems. In the case of an application having a small vocabulary, a deterministic grammar has been formulated as a finite state network (FSN), such as in an airline reservation and information system (see Rabiner, L. R. and Levinson, S. Z., A Speaker-Independent, Syntax-Directed, Connected Word Recognition System Based on Hidden Markov Model and Level Building, IEEE Trans. on IASSP, Vol. 33, No. 3, June 1985).

The Acoustic Processor 4 represents a frontend speech analysis subsystem in the voice recognizer 2. In response to an input speech signal, it provides an appropriate representation to characterize the time-varying speech signal. It should discard irrelevant information such as background noise, channel distortion, speaker characteristics and manner of speaking. An efficient acoustic feature will furnish voice recognizers with higher acoustic discrimination power. The most useful characteristic is the short time spectral envelope. In characterizing the short time spectral envelope, a commonly used spectral analysis technique is filter-bank based spectral analysis.

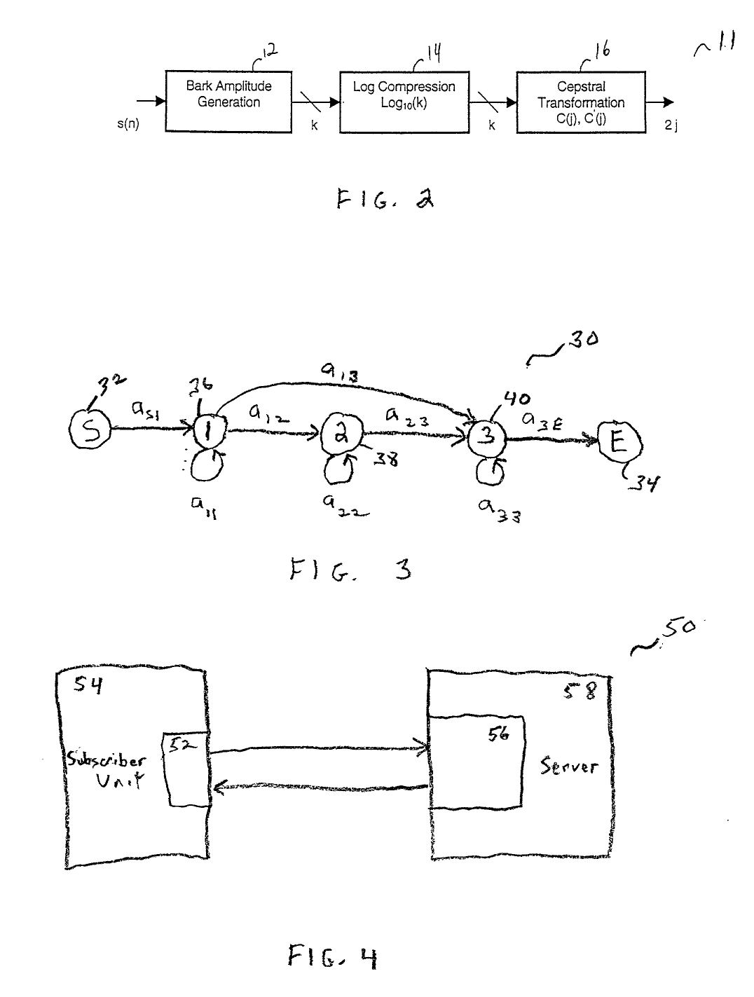

FIG. 2 shows a VR frontend 11 in a VR system in accordance with one embodiment. The frontend 11 performs frontend processing in order to characterize a speech segment. Cepstral parameters are computed once every T msec from PCM input. It would also be understood by those skilled in the art that any period of time may be used for T.

A Bark Amplitude Generation Module 12 converts a digitized PCM speech signal s(n) to k bark amplitudes once every T milliseconds. In one embodiment, T is 10 msec and k is 16 bark amplitudes. Thus, there are 16 bark amplitudes every 10 msec. It would be understood by those skilled in the art that k could be any positive integer.

The Bark scale is a warped frequency scale of critical bands corresponding to human perception of hearing. Bark amplitude calculation is known in the art and described in Rabiner, L. R. and Juang, B. H., Fundamentals of Speech Recognition, Prentice Hall, (1993).

The Bark Amplitude module 12 is coupled to a Log Compression module 14. In a typical VR frontend, the Log Compression module 14 transforms the bark amplitudes to a log₁₀ scale by calculating the logarithm of each bark amplitude. However, a system and method that uses Mu-law compression and A-law compression techniques instead of the simple log₁₀ function in the VR frontend improves the accuracy of the VR frontend in noisy environments as described in U.S. patent application No. 09/703,191, entitled “System And Method For Improving Voice Recognition In Noisy Environments And Frequency Mismatch Conditions,” filed Oct. 31, 2000, which is assigned to the assignee of the present invention and fully incorporated herein by reference. Mu-law compression of bark amplitudes and A-law compression of bark amplitudes are used to reduce the effects of noisy environments, and thereby improve the overall accuracy of the voice recognition system. In addition, RelAtive SpecTrAl (RASTA) filtering may be used to filter convolutional noise.

In the VR frontend 11, the Log Compression module 14 is coupled to a Cepstral Transformation module 16. The Cepstral Transformation module 16 computes j static cepstral coefficients and j dynamic cepstral coefficients. Cepstral transformation is a cosine transformation that is well known in the art. It would be understood by those skilled in the art that j can be any positive integer. Thus, the frontend module 11 generates 2*j coefficients, once every T milliseconds. These features are processed by a backend module (a word decoder, not shown), such as a hidden Markov modeling (HMM) system to perform voice recognition.

An HMM module models a probabilistic framework for recognizing an input speech signal. In an HMM model, both temporal and spectral properties are used to characterize a speech segment. Each HMM model (whole word or sub-word) is represented by a series of states and a set of transition probabilities. FIG. 3 shows an example HMM model for a speech segment. The HMM model could represent a word, “oh,” or a part of a word, “Ohio.” The input speech signal is compared to a plurality of HMM models using Viterbi decoding. The best matching HMM model is considered to be the resultant hypothesis. The HMM model 30 has five states, start 32, end 34, and three states for the represented triphone: state one 36, state two 38, and state three 40.

Transition a is the probability of transitioning from state i to state j. aₛ₁ transitions from the start state 32 to the first state 36. a₁₂ transitions from the first state 36 to the second state 38. a₂₃ transitions from the second state 38 to the third state 40. a_{3E} transitions from the third state 40 to the end state 34. a₁₁ transitions from the first state 36 to the first state 36. a₂₂ transitions from the second state 38 to the second state 38. a₃₃ transitions from the third state 40 to the third state 40. a₁₃ transitions from the first state 36 to the third state 40.

A matrix of transition probabilities can be constructed from all transitions/probabilities: aᵢⱼ, wherein n is the number of states in the HMM model; i=1, 2, . . . , n; j=1, 2, . . . , n. When there is no transition between states, that transition/probability is zero. The cumulative transition/probabilities from a state is unity, i.e., equals one.

HMM models are trained by computing the “j” static cepstral parameters and “j” dynamic cepstral parameters in the VR frontend. The training process collects a plurality of N frames that correspond to a single state. The training process then computes the mean and variance of these N frames, resulting in a mean vector of length 2j and a diagonal covariance of length 2j. The mean and variance vectors together are called a Gaussian mixture component, or “mixture” for short. Each state is represented by N Gaussian mixture components, wherein N is a positive integer. The training process also computes transition probabilities.

In devices with small memory resources, N is 1 or some other small number. In a smallest footprint VR system, i.e., smallest memory VR system, a single Gaussian mixture component represents a state. In larger VR systems, a plurality of N frames is used to compute more than one mean vector and the corresponding variance vectors. For example, if a set of twelve means and variances is computed, then a 12-Gaussian-mixture-component HMM state is created. In VR servers in DVR, N can be as high as 32.

Combining multiple VR systems (also called VR engines) provides enhanced accuracy and uses a greater amount of information in the input speech signal than a single VR system. A system and method for combining VR engines is described in U.S. patent application No. 09/618,177 (hereinafter '177 application), entitled “Combined Engine System and Method for Voice Recognition”, filed Jul. 18, 2000, and U.S. patent application No. 09/657,760 (hereinafter '760 application), entitled “System and Method for Automatic Voice Recognition Using Mapping,” filed Sep. 8, 2000, which are assigned to the assignee of the present invention and fully incorporated herein by reference.

In one embodiment, multiple VR engines are combined in a Distributed VR system. Thus, there is a VR engine on both the subcriber unit and a network server. The VR engine on the subscriber unit is a local VR engine. The VR engine on the server is a network VR engine. The local VR engine comprises a processor for executing the local VR engine and a memory for storing speech information. The network VR engine comprises a processor for executing the network VR engine and a memory for storing speech information.

In one embodiment, the local VR engine is not the same type of VR engine as the network VR engine. It would be understood by those skilled in the art that the VR engines can be any type of VR engine known in the art. For example, in one embodiment, the subscriber unit is a DTW VR engine and the network server is an HMM VR engine, both types of VR engines being known in the art. Combining different types of VR engines improves the accuracy of the distributed VR system because the DTW VR engine and the HMM VR engine have different emphases when processing an input speech signal, which means that more information of the input speech signal is used when the Distributed VR system processes the input speech signal than when a single VR engine processes the input speech signal. A resultant hypothesis is chosen from hypotheses combined from the local VR engine and the server VR engine.

In one embodiment, the local VR engine is the same type of VR engine as the network VR engine. In one embodiment, the local VR engine and the network VR engine are HMM VR engines. In another embodiment, the local VR engine and the network VR engine are DTW engines. It would be understood by those skilled in the art that the local VR engine and the network VR engine can be any VR engine known in the art.

The VR engine obtains speech data in the form of PCM signals. The engine processes the signal until a valid recognition is made or the user has stopped speaking and all speech has been processed. In a DVR architecture, the local VR engine obtains PCM data and generates frontend information. In one embodiment, the frontend information is cepstral parameters. In another embodiment, the frontend information can be any type of information/features that characterizes the input speech signal. It would be understood by those skilled in the art that any type of features known to one skilled in the art might be used to characterize the input speech signal.

For a typical recognition task, the local VR engine obtains a set of trained templates from its memory. The local VR engine obtains a grammar specification from an application. An application is service logic that enables users to accomplish a task using the subscriber unit. This logic is executed by a processor on the subscriber unit. It is a component of a user interface module in the subscriber unit.

The grammar specifies the active vocabulary using sub-word models. Typical grammars include 7-digit phone numbers, dollar amounts, and a name of a city from a set of names. Typical grammar specifications include an “Out of Vocabulary (OOV)” condition to represent the condition where a confident recognition decision could not be made based on the input speech signal.

In one embodiment, the local VR engine generates a recognition hypothesis locally if it can handle the VR task specified by the grammar. The local VR engine transmits frontend data to the VR server when the grammar specified is too complex to be processed by the local VR engine.

In one embodiment, the local VR engine is a subset of the network VR engine in the sense that each state of the network VR engine has a set of mixture component(s) and each corresponding state of the local VR engine has a subset of the set of mixture component(s). The size of a subset is less than or equal to the size of the set. For each state in the local VR engine and the network VR engine, a state of the network VR engine has N mixture components and a state of the local VR engine has ≦N mixture components. Thus, in one embodiment, the subcriber unit includes a low memory footprint HMM VR engine that has fewer mixtures per state than a large memory footprint HMM VR engine on the network server.

In DVR, memory resources in the VR server are inexpensive. Further, each server is time shared by many ports providing DVR services. By using a large number of mixture components, the VR system works well for a large corpus of users. By contrast, VR in a small device is not used by many people. Thus, in a small device, it is possible to use a small number of Gaussian mixture components and adapt them to the user's speech.

In a typical backend, a whole word model is used with small vocabulary VR systems. In medium-to-large vocabulary systems, sub-word models are used. Typical sub-word units are context-independent (CI) phones and context-dependent dependent (CD) phones. A Context-independent phone is independent of the phones to the left and right. Context-dependent phones are also called triphones because they depend on the phones to the left and right of it. Context-dependent phones are also called allophones.

A phone in the VR art is the realization of a phoneme. In a VR system, context independent phone models and context dependent phone models are built using HMMs or other types of VR models known in the art. A phoneme is an abstraction of the smallest functional speech segment in a given language. Here, the word functional implies perceptually different sounds. For example, replacing the “k” sound in “cat” by the “b” sound results in a different word in the English language. Thus, “b” and “k” are two different phonemes in English language.

Both CD and CI phones can be represented by a plurality of states. Each state is represented by a set of mixtures, wherein a set can be a single mixture or a plurality of mixtures. The greater the number of mixtures per state, the more accurate the VR system is for recognizing each phone.

In one embodiment, the local VR engine and the server-based VR engine are not based on the same kind of phones. In one embodiment, the local VR engine is based on CI phones and the server-based VR engine is based on CD phones. The local VR engine recognizes CI phones. The server-based VR engine recognizes CD phones. In one embodiment, the VR engines are combined as described in the '177 application. In another embodiment, the VR engines are combined as described in the '760 application.

In one embodiment, the local VR engine and the server-based VR engine are based on the same kind of phones. In one embodiment, the local VR engine and the server-based VR engine are both based on CI phones. In another embodiment, the local VR engine and the server-based VR engine are both based on CD phones.

Each language has phonotactic rules that determine the valid phonetic sequences for that language. There are tens of CI phones recognized in a given language. For example, a VR system that recognizes the English language may recognize around 50 CI phones. Thus, only a few models are trained and then used in recognition.

The memory requirements for storing CI models are small compared with those for CD phones. For the English language, considering the left context and right context for each phone, there are 50×50×50 CD phones. However, not all contexts occur in the English language. Out of all possible contexts, only a subset is used in the language. Out of all of the contexts used in a language, only a subset of those contexts is processed by a VR engine. Typically, few thousands of triphones are used in a VR server residing in the network for DVR. The memory requirement for a VR system based on CD phones is more than the requirement for a VR system based on CI phones.

In one embodiment, the local VR engine and the server-based VR engine share some mixture components. The server VR engine downloads mixture components to the local VR engine.

In one embodiment, K Gaussian mixture components used in the VR server are used to generate a smaller number of mixtures, L, that are downloaded to the subscriber unit. This number L could be as small as one, depending on the space available in the subscriber unit for storing templates locally. In another embodiment, the small number of mixtures L is initially included in the subscriber unit.

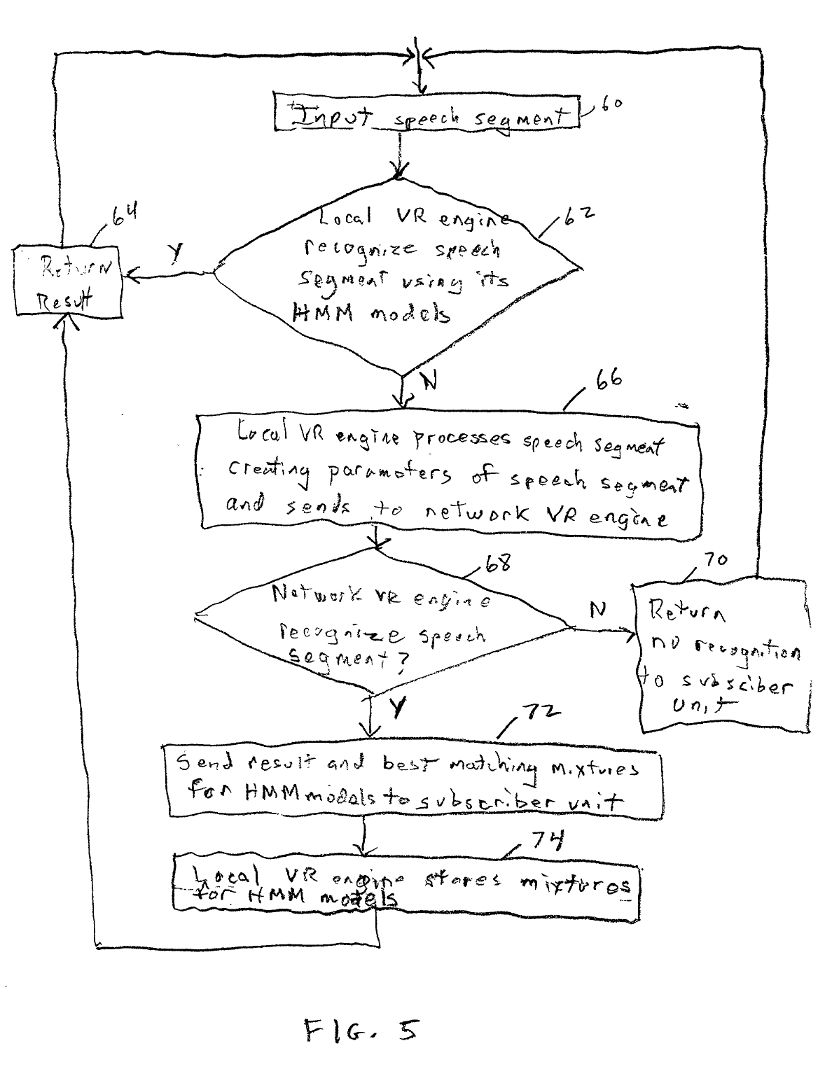

FIG. 4 shows a DVR system 50 with a local VR engine 52 in a subscriber unit 54 and a server VR engine 56 on a server 58. When a server-based DVR transaction is initiated, the server 58 obtains frontend data for voice recognition. In one embodiment, during recognition the server 58 keeps track of the best L mixture components for each state in a final decoded state sequence. If the recognized hypothesis is accepted by the application as a correct recognition and an appropriate action is taken based on the recognition, then the L mixture components describe the user's speech are better than the remaining K-L mixtures used to describe a given state.

When the local VR engine 52 does not recognize a speech segment, the local VR engine 52 requests that the server VR engine 56 recognize the speech segment. The local VR engine 52 sends features it extracted from the speech segment to the server VR engine 56. If the server VR engine 56 recognizes the speech segment, it downloads mixtures corresponding to the recognized speech segment into the memory of the local VR engine 52. In another embodiment, the mixtures are downloaded for every successful transaction. In another embodiment, the mixtures are downloaded after a number of successful transactions. In one embodiment, the mixtures are downloaded after a period of time.

In one embodiment, the local VR engine uploads mixtures to the server VR engine after being trained for a speech segment. The local VR engine is trained for speaker adaptation. That is, the local VR engine adapts to a user's speech.

In one embodiment, the downloaded features from the server VR engine 56 are added to the memory of the local VR engine 52. In one embodiment, downloaded mixtures are combined with mixtures of the local VR engine to create resultant mixtures used by the local VR engine 52 to recognize a speech segment. In one embodiment, a function is applied to the downloaded mixtures and the resultant mixtures are added to the memory of the local VR engine 52. In one embodiment, the resultant mixtures are a function of the downloaded mixtures and mixtures on the local VR engine 52. In one embodiment, the resultant mixtures are sent to the server VR engine 56 for speaker adaptation. The local VR engine 52 has a memory for receiving mixtures and has a processor for applying a function to the mixtures and for combining mixtures.

In one embodiment, following a successful transaction, the server downloads the L mixture components to the subscriber unit. Gradually, the VR capability of the subscriber unit 54 improves as the set of HMM models is adapted to the user's speech. As the set of HMM models is adapted to the user's speech, the local VR engine 52 makes less requests of the server VR engine 56.

It would be apparent to those skilled in the art that a mixture is one type of information about a speech segment and that any information that characterizes a speech segment can be downloaded from the server VR engine 56 and uploaded to the server VR engine 56 and is within the scope of the invention.

Downloading mixtures from the server VR engine 56 to the local VR engine 52 increases the accuracy of the local VR engine 52. Uploading mixtures from the local VR engine 52 to the server VR engine 56 increases the accuracy of the server VR engine.

The local VR engine 52 with small memory resources can approach the performance of a network-based VR engine 56 with significantly large memory resources, for a specific user. Typical DSP implementations have enough MIPS to handle such tasks locally without causing too much network traffic.

In most situations, adapting the speaker independent models results in improving the VR accuracy compared to no such adaptation. In one embodiment, adaptation involves adjusting the mean vectors of the mixture components of a given model to be closer to the frontend features of the speech segments corresponding to the model, as spoken by the speaker. In another embodiment, adaptation involves adjusting other model parameters based on the speaker's speaking style.

For adaptation, a segmentation of the adaptation utterances aligned with corresponding model states is required. Typically, such information is available during the training process but not during actual recognition. This is because of additional memory storage requirements (RAM) to generate and save the segmentation information. This is particularly true in the case of local VR implemented in an embedded platform, such as a cellular telephone.

One advantage of network-based VR is that the restrictions on RAM usage are much less stringent. So, in DVR applications, the network-based backend can create the segmentation information. Further, the network-based backend can compute the new sets of means based on the frontend features received. Finally, the network can download these parameters to the mobile.

FIG. 5 shows a flowchart of a VR recognition process in accordance with one embodiment. When a user speaks into a subcriber unit, the subcriber unit divides the user's speech into speech segments. In step 60, the local VR engine processes the input speech segment. In step 62, the local VR engine attempts to recognize the speech segment by using its HMM models to generate a result. The result is a phrase comprised of at least one phone. The HMM models are comprised of mixtures. In step 64, if the local VR engine recognizes the speech segment, then it returns the result to the subscriber unit. In step 66, if the local VR engine does not recognize the speech segment, then the local VR engine processes the speech segment, thereby creating parameters of the speech segment, which are sent to the network VR engine. In one embodiment, the parameters are cepstral parameters. It would be understood by those skilled in the art that the parameters generated by the local VR engine can be any parameters known in the art to represent a speech segment.

In step 68, the network VR engine attempts to interpret the parameters of the speech segment using its HMM models, i.e., attempts to recognize the speech segment. In step 70, if the network VR engine does not recognize the speech segment, then the fact that recognition could not be performed is sent to the local VR engine. In step 72, if the network VR engine does recognize the speech segment, then both the result and the best matching mixtures for the HMM models used to generate the result are sent to the local VR engine. In step 74, the local VR engine stores the mixtures for the HMM models in its memory to be used for recognizing the next speech segment generated by the user. In step 64, the local VR engine returns the result to the subscriber unit. In step 60, another speech segment is input into the local VR engine.

Thus, a novel and improved method and apparatus for voice recognition has been described. Those of skill in the art would understand that the various illustrative logical blocks, modules, and mapping described in connection with the embodiments disclosed herein may be implemented as electronic hardware, computer software, or combinations of both. The various illustrative components, blocks, modules, circuits, and steps have been described generally in terms of their functionality. Whether the functionality is implemented as hardware or software depends upon the particular application and design constraints imposed on the overall system. Skilled artisans recognize the interchangeability of hardware and software under these circumstances, and how best to implement the described functionality for each particular application. As examples, the various illustrative logical blocks, modules, and mapping described in connection with the embodiments disclosed herein may be implemented or performed with a processor executing a set of firmware instructions, an application specific integrated circuit (ASIC), a field programmable gate array (FPGA) or other programmable logic device, discrete gate or transistor logic, discrete hardware components such as, e.g., registers, any conventional programmable software module and a processor, or any combination thereof designed to perform the functions described herein. The local VR engine 52 on the subscriber unit 54 and the server VR engine 56 on a server 58 may advantageously be executed in a microprocessor, but in the alternative, the local VR engine 52 and the server VR engine 56 may be executed in any conventional processor, controller, microcontroller, or state machine. The templates could reside in RAM memory, flash memory, ROM memory, EPROM memory, EEPROM memory, registers, hard disk, a removable disk, a CD-ROM, or any other form of storage medium known in the art. The memory (not shown) may be integral to any aforementioned processor (not shown). A processor (not shown) and memory (not shown) may reside in an ASIC (not shown). The ASIC may reside in a telephone.

The previous description of the embodiments of the invention is provided to enable any person skilled in the art to make or use the present invention. The various modifications to these embodiments will be readily apparent to those skilled in the art, and the generic principles defined herein may be applied to other embodiments without the use of the inventive faculty. Thus, the present invention is not intended to be limited to the embodiments shown herein but is to be accorded the widest scope consistent with the principles and novel features disclosed herein.

We claim:

1. A subscriber unit for use in a communication system, comprising:
means for receiving information of a speech segment; and
means for combining the received information with speech segment information of a local voice recognition system.

2. The subscriber unit of claim 1, wherein the received information is Gaussian mixtures.

3. A subscriber unit for use in a communication system, comprising:
means for receiving information of a speech segment; and
means for applying a function to the received information to create resultant speech information.

4. The subscriber unit of claim 3, wherein the received information and the resultant speech information is Gaussian mixtures.

5. A method of voice recognition, comprising:
receiving speech segment information;
combining the received speech segment information with local speech segment information to generate combined speech segment information; and
using the combined speech segment information to recognize a speech segment.

6. A method of voice recognition, comprising:
receiving speech segment information;
applying a function to the received speech segment information to generate resultant speech segment information; and
using the resultant speech segment information to recognize a speech segment.

7. A method of voice recognition, comprising:
receiving speech segment information;
combining the received speech segment information with local features;
applying a function to the combined information to generate resultant speech information; and
using the resultant speech information to recognize a speech segment.

8. A method of voice recognition for use in a communication system, comprising:
receiving frontend features of a speech segment; and
comparing the frontend features with speech segment information.

9. The method of claim 8, further comprising selecting matching speech segment information based on the comparison.

10. A method of voice recognition, comprising:
sending features of a speech segment;
receiving speech segment information;
applying a function to the received information to generate resultant speech information;
combining the resultant speech information with local speech segment information; and
using the combined information to recognized a speech segment.

11. A method of voice recognition, comprising:
receiving a speech segment;
processing the speech segment to create parameters of the speech segment;
sending the parameters to a network voice recognition (VR) engine;
comparing the parameters to hidden Markov modeling (HMM) models; and
sending mixtures of the HMM models that correspond to the parameters to a local VR engine.

12. The method of claim 11, further comprising receiving the mixtures.

13. The method of claim 12, further comprising storing the mixtures into memory.

14. A distributed voice recognition system, comprising:
a local VR engine on a subscriber unit that receives mixtures used to recognize a speech segment; and
a network VR engine on a server that sends the mixtures to the local VR engine.

15. The distributed voice recognition system of claim 14, wherein the local VR engine is one type of VR engine.

16. The distributed voice recognition system of claim 15, wherein the network VR engine is another type of VR engine.

17. The distributed voice recognition system of claim 16, wherein the received mixtures are combined with mixtures of the local VR engine.

18. A distributed voice recognition system, comprising:
a local VR engine on a subscriber unit that sends mixtures as a result of training to a network VR engine; and
a network VR engine on a server that receives the mixtures used to recognize a speech segment.
